(19) United States
(12) Patent Application Publication
(10) Pub. No.: US 2015/0086821 A1
(43) Pub. Date: Mar. 26, 2015

(54) FLAT WOUND SECONDARY BATTERY AND METHOD FOR PRODUCING SAME

(71) Applicant: Hitachi Automotive Systems, Ltd., Hitachinaka-shi, Ibaraki (JP)

(72) Inventors: Satoshi Watanabe, Hitachinaka (JP); Toshiyuki Ariga, Hitachinaka (JP)

(73) Assignee: HITACHI AUTOMOTIVE SYSTEMS, LTD., Hitachinaka-shi, Ibaraki (JP)

(21) Appl. No.: 14/398,240

(22) PCT Filed: Jan. 18, 2013
(86) PCT No.: PCT/JP2013/050929

§ 371 Date: Oct. 31, 2014

(30) Foreign Application Priority Data
May 1, 2012 (WO) PCTJP2012/061573

(51) Int. Cl. H01M 10/04

(52) U.S. Cl. CPC H01M 10/0431
USPC 429/94; 29/623.1

(57) ABSTRACT

A flat wound secondary battery and a method for producing the same provides for the suppression of wrinkles formed on an electrode by irregularities on a welded portion. A secondary battery has a wound electrode body including a positive electrode and a negative electrode that are wound flat around a shaft core with a separator interposed between the electrodes, and a battery container that contains the wound electrode body. The shaft core includes a wound resin sheet having higher flexural rigidity than the positive electrode, the negative electrode, and the separator. The shaft core includes an innermost portion that forms the innermost periphery of the shaft core and an extended portion to a winding terminal end from the innermost portion. The separator includes a bonded portion to the extended portion and a separator winding portion that winds only the separator at least one turn around the shaft core.

### TECHNICAL FIELD

The present invention relates to, for example, an on-board flat wound secondary battery having high capacity and a method for producing the same.

### BACKGROUND ART

In recent years, lithium-ion secondary batteries including positive and negative electrodes with separators interposed between the electrodes have been developed with high energy densities as the power sources of electric vehicles and so on. As lithium-ion secondary batteries have been widely used with higher performance, a simple production process and low cost have been required. Under the present circumstances, a technique is disclosed in which a shaft core having a wound electrode is, for example, a stainless shaft core or a seamless cylinder of synthetic resin, and the ring-shaped shaft core is flattened with a wound electrode body after the winding of the electrode (Patent Literature 1).

### CITATION LIST

### Patent Literature

Patent Literature 1: Japanese Unexamined Patent Application Published No. 2002-280055

### SUMMARY OF INVENTION

### Technical Problem

The related art requires insertion of the cylindrical core onto the spindle of a winder before the electrode is wound by the winder. This may suppress productivity improved by automation. Moreover, if separators are welded to the resin core, irregularities on a welded portion may wrinkle the electrodes and form a gap between the electrodes.

The present invention has been devised in view of the problem. An object of the present invention is to provide a flat wound secondary battery and a method for producing the same with a simple structure that can simplify a production process and suppress wrinkles formed on an electrode by irregularities on a welded portion.

### Solution to Problem

The present invention includes multiple solutions, for example, a flat wound secondary battery having a wound electrode body including a positive electrode and a negative electrode that are wound flat around a shaft core with a separator interposed between the electrodes, the shaft core including a wound resin sheet having higher flexural rigidity than the positive electrode, the negative electrode, and the separator, the shaft core including an innermost portion that forms the innermost periphery of the shaft core and an extended portion to a winding terminal end of the resin sheet from the innermost portion, and the separator including a bonded portion to the extended portion and a separator winding portion that winds only the separator at least one turn around the shaft core so as to connect the separator to the bonded portion.

### Advantageous Effects of Invention

The present invention can provide a flat wound secondary battery and a method for producing the same with a simple structure that can simplify a production process with high reliability. Other problems, configurations, and effects will be clarified in the following embodiments:

### BRIEF DESCRIPTION OF DRAWINGS

FIG. 1 is an external perspective view of a lithium-ion secondary battery according to a first embodiment.

FIG. 2 is an exploded perspective view of the lithium-ion secondary battery shown in FIG. 1.

FIG. 3 is an exploded perspective view of a power generating element assembly shown in FIG. 2.

FIG. 4A is a developed perspective view of a wound electrode body shown in FIG. 3.

FIG. 4B is an explanatory drawing showing the configuration of a shaft core and a schematic diagram viewed in a direction B of FIG. 4A.

FIG. 4C shows the flattened shaft core.

FIG. 5 shows the positional relationship among a resin sheet, a separator, a negative plate, and a positive plate at the beginning of winding.

FIG. 6 is a structural example of the winder.

FIG. 7 is a schematic diagram for explaining the resin sheet wound around a winding core.

FIG. 8A is a cross-sectional conceptual diagram showing a bonded structure of the shaft core and the separators according to the first embodiment.

FIG. 8B is an explanatory drawing of a winding method around the shaft core according to the first embodiment.

FIG. 9 is a cross-sectional conceptual diagram showing an example of a method of bonding the shaft core and the separators according to the first embodiment.

FIG. 10 is a cross-sectional conceptual diagram showing a bonded structure of a shaft core and separators according to a second embodiment.

FIG. 11 is a cross-sectional conceptual diagram showing an example of a method of bonding the shaft core and the separators according to the second embodiment.

FIG. 12 is a cross-sectional conceptual diagram showing a bonded structure of a shaft core and separators according to a third embodiment.

FIG. 13 is a cross-sectional conceptual diagram showing a method of bonding the shaft core and the separators according to the third embodiment.

FIG. 14 is a cross-sectional conceptual diagram showing a bonded structure of a shaft core and separators according to a fourth embodiment.

FIG. 15A is an explanatory drawing of a winding method of a shaft core according to a fifth embodiment.

FIG. 15B is a cross-sectional conceptual diagram showing a bonded structure of the shaft core and separators according to the fifth embodiment.

### DESCRIPTION OF EMBODIMENTS

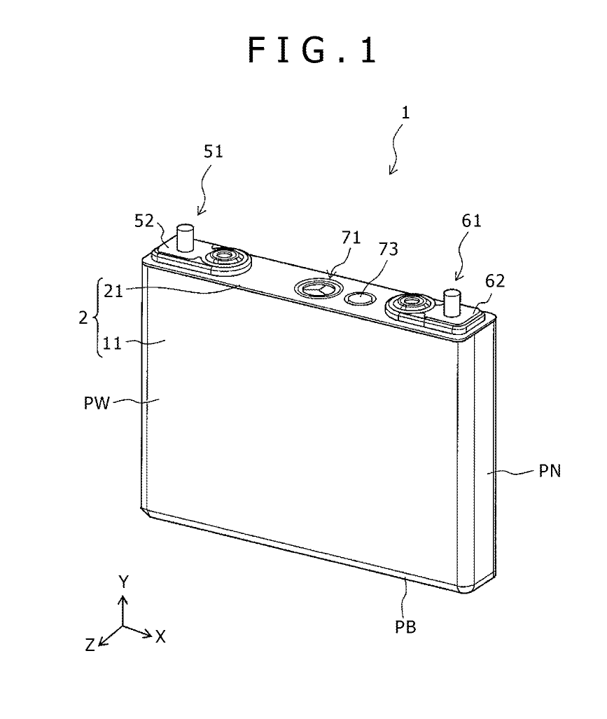

Referring to FIGS. 1 to 15B, embodiments of the present invention will be described below.

The present invention is a flat wound secondary battery that has a flat wound electrode body around a shaft core with a separator interposed between a positive electrode and a negative electrode. The shaft core includes a resin sheet wound with higher flexural rigidity than the positive electrode, the negative electrode, and the separator. The shaft core includes an innermost portion that forms the innermost periphery of the shaft core and an extended portion to a winding terminal end from the innermost portion. The separator includes a bonded portion to the extended portion and a separator winding portion that winds only the separator at least one turn around the shaft core so as to connect to the bonded portion.

### First Embodiment

In the present embodiment, an example of a lithium-ion secondary battery as a flat wound secondary battery will be described below.

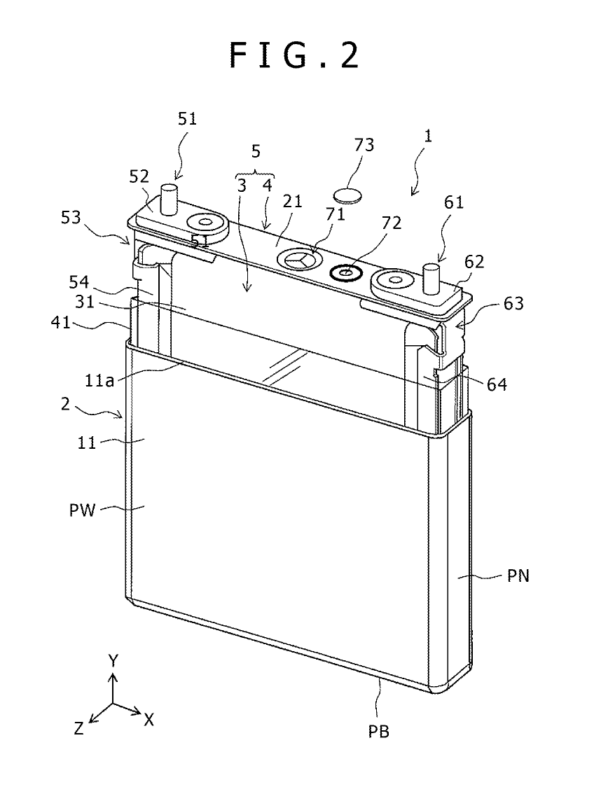

FIG. 1 is an external perspective view of the lithium-ion secondary battery according to the present embodiment. FIG. 2 is an exploded perspective view of the lithium-ion secondary battery shown in FIG. 1.

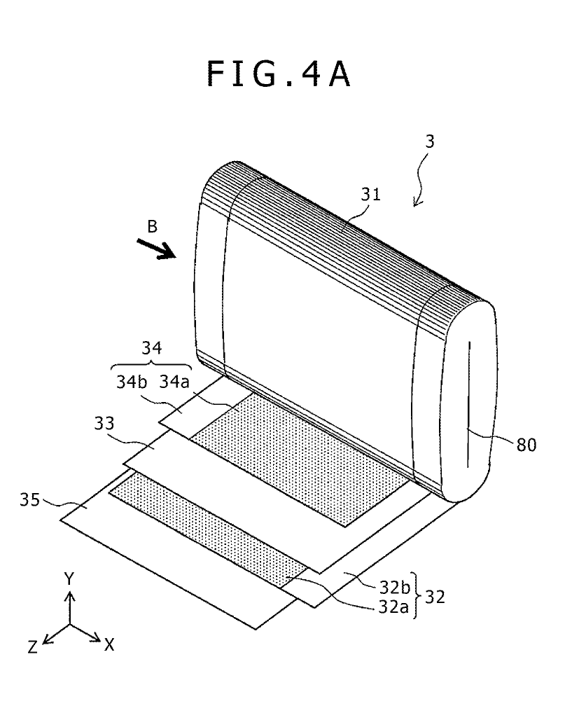

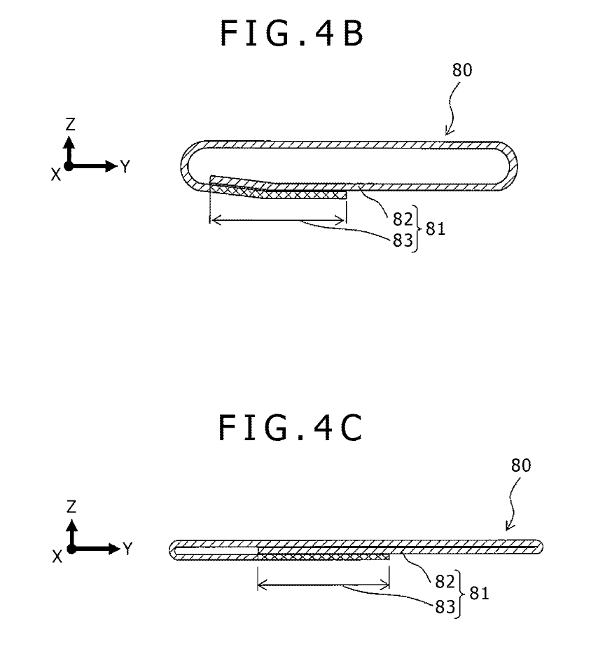

As shown in FIGS. 1 and 2, a lithium-ion secondary battery 1 includes a battery container 2 that contains a wound electrode body 3. The battery container 2 includes a battery case 11 having an opening 11a and a battery lid 21 that closes the opening 11a of the battery case 11. As shown in FIG. 4A, the wound electrode body 3 includes a positive plate 34 and a negative plate 32 that are stacked with separators 33 and 34 interposed between the positive and negative plates 34 and 32. In this state, the wound electrode body 3 is flat wound around a resin sheet 81 wrapped around a winding core 110 of a winder 100. The wound electrode body 3 with a sheet insulating protective film 41 disposed around the wound electrode body 3 is stored in the battery container 2.

The battery container 2 includes the battery case 11 and the battery lid 21. The battery case 11 and the battery lid 21 are both made of an aluminum alloy. The battery lid 21 is welded to the battery case 11 by laser welding. The battery container 2 is a flat square container shaped like a rectangular parallelepiped includes a pair of wide sides PW, a pair of narrow sides PN, a bottom PB, and the battery lid 21. A positive terminal 51 and a negative terminal 61 (a pair of electrode terminals) are disposed on the battery lid 21 with an insulating member interposed between the terminals and the battery lid 21. The positive and negative terminals 51 and 61 constitute a lid assembly 4. In addition to the positive terminal 51 and the negative terminal 61, the battery lid 21 includes a gas release vent 71 that is opened to discharge gas in the battery container 2 when a pressure in the battery container 2 exceeds a predetermined value, and an electrolyte inlet 72 that fills the battery container 2 with an electrolyte.

The positive terminal 51 and the negative terminal 61 are longitudinally separated from each other on one side and the other side of the battery lid 21. The positive terminal 51 and the negative terminal 61 have external terminals 52 and 62 that are disposed outside the battery lid 21 and connection terminals 53 and 63 that are disposed inside the battery lid 21 so as to be electrically connected to the external terminals 52 and 62. The external terminal 52 and the connection terminal 53 on the positive side are made of an aluminum alloy while the external terminal 62 and the connection terminal 63 on the negative side are made of a copper alloy.

The connection terminals 53 and 63 and the external terminals 52 and 62 are disposed with an insulting member (not shown) interposed between the terminals and the battery lid 21, electrically insulating the terminals from the battery lid 21. The connection terminals 53 and 63 include current collecting terminals 54 and 64 that are extended from the inside of the battery lid 21 to the bottom of the battery case 11 so as to be electrically connected to the wound electrode body 3. The wound electrode body 3 is disposed so as to be supported between the current collecting terminal 54 of the positive terminal 51 and the current collecting terminal 64 of the negative terminal 61. The lid assembly 4 and the wound electrode body 3 constitute a power generating element assembly 5.

Subsequently, in order to obtain insulation between the power generating element assembly 5 and the battery case 11, the wound electrode body 3 is inserted from the opening 11a of the battery case 11 so as to locate the insulating protective film 41 between the power generating element assembly 5 and the battery case 11, and then the battery lid 21 and the battery case 11 are welded by laser welding. After that, an electrolyte is poured into the battery container 2 from the electrolyte inlet 72 of the battery lid 21, and then the electrolyte inlet 72 is closed by an electrolyte stopper 73. The electrolyte stopper 73 is welded to the battery lid 21 by laser welding.

The electrolyte contains, for example, 1 mol/L of LiPF₆ (lithium hexafluorophosphate) in a mixed solution of ethylene carbonate (EC), dimethyl carbonate (DMC), and diethyl carbonate (DEC) with a volume ratio of 1:1:1.

In this example, the electrolyte is LiPF₆. The electrolyte is not limited to LiPF₆ and may be, for example, LiClO₄, LiAsF₆, LiBF₄, LiB(C₆H₅)₄, CH₃SO₃Li, CF₃SOLi, or a mixture of these substances. Moreover, a solvent for a non-aqueous electrolyte is a mixed solvent of EC and DMC in the example of the present embodiment. Alternatively, the mixed solvent may contain at least one of propylene carbonate, ethylene carbonate, dimethyl carbonate, diethyl carbonate, 1,2-dimethoxyethane, 1,2-diethoxyethane, γ-butyrolactone, tetrahydrofuran, 1,3-dioxolane, 4-methyl-1,3-dioxolane, diethyl ether, sulfolane, methylsulfolane, acetonitrile, and propionitrile. The mixing ratio is not limited. Power is supplied from the wound electrode body 3 to an external load through the external terminals 52 and 62, or external generated power is charged to the wound electrode body 3 through the external terminals 52 and 62.

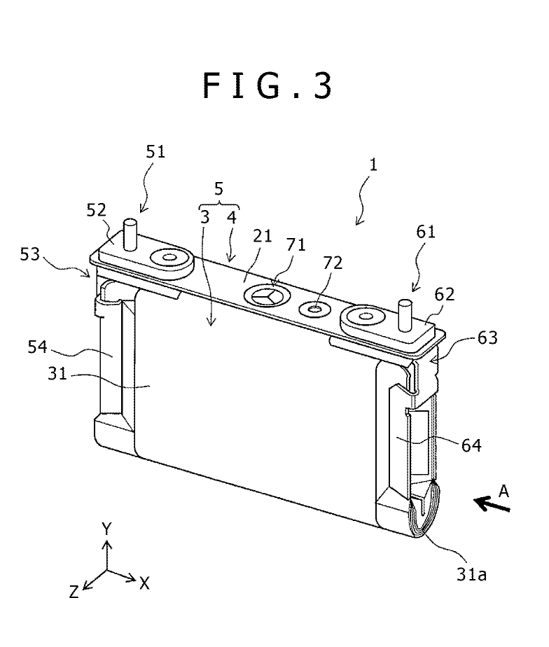

FIG. 3 is an exploded perspective view of the detail of the power generating element assembly shown in FIG. 2.

The power generating element assembly 5 is fabricated as follows: the positive terminal 51 and the negative terminal 61 are attached to the battery lid 21 via the insulating member to fabricate the lid assembly 4, and then a positive uncoated portion 34b and a negative uncoated portion 32b of the wound electrode body 3 are electrically connected to the positive terminal 51 and the negative terminal 61 of the lid assembly 4 by ultrasonic bonding.

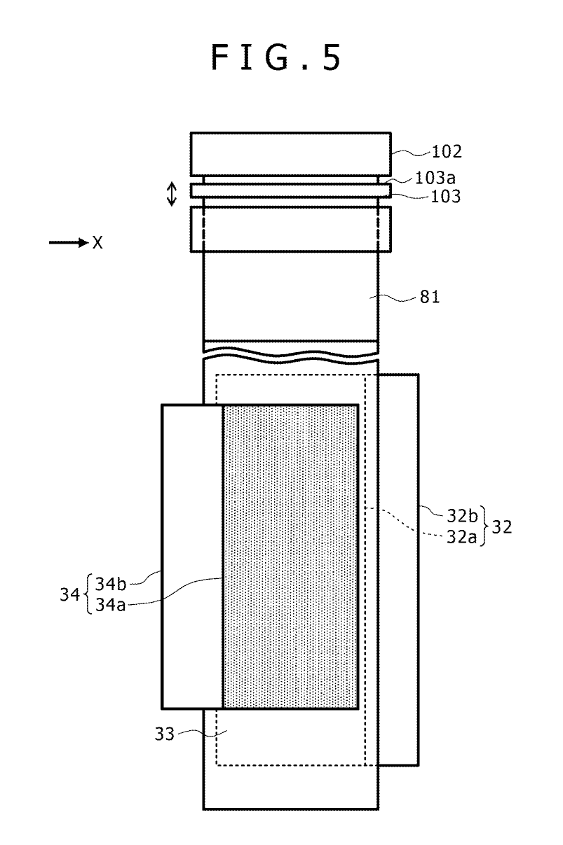

FIG. 4A is an external perspective view specifically showing a developed part of the wound electrode body in FIG. 3. FIG. 4B is an explanatory drawing showing the configuration of a shaft core 80 and a schematic diagram viewed in a direction B of FIG. 4A. FIG. 4C shows the flattened shaft core. FIG. 5 is a developed view of the positional relationship among the resin sheet, the separator, the negative plate, and the positive plate at the beginning of winding.

The wound electrode body 3 includes the negative plate (negative electrode) 32 and the positive plate (positive electrode) 34 that are wound flat around the shaft core 80 with the separators 33 and 35 interposed between the plates. As shown in FIG. 4A, the outermost electrode of the wound electrode body 3 is the negative plate 32 on which the separator 35 is wound. The separators 33 and 35 insulate the positive plate 34 from the negative plate 32.

As shown in FIG. 5, a negative coated portion 32a of the negative plate 32 is larger in width than a positive coated portion 34a of the positive plate 34. Thus, the positive uncoated portion 34a is always held by the negative coated portion 32a. The positive uncoated portion 34b and the negative uncoated portion 32b are connected to the positive and negative current collecting terminals 54 and 64 that are bundled on a flat portion and are connected to the external terminals 52 and 62 by welding or the like. The separators 33 and 35 are larger in width than the negative coated portion 32a but are wound at positions where metal foil surfaces are exposed on the ends of the positive uncoated portion 34b and the negative uncoated portion 32b. This does not hamper welding of the bundled terminals.

The positive plate 34 has the positive coated portion 34a formed by applying a positive active material mixture to both surfaces of positive electrode foil serving as a positive current collector, and the positive uncoated portion (foil exposed portion) 34b not coated with a positive active material mixture on one end in the width direction of the positive electrode foil.

The negative plate 32 has the negative coated portion 32a formed by applying a negative active material mixture to both surfaces of negative electrode foil serving as a negative current collector, and the negative uncoated portion (foil exposed portion) 32b not coated with a negative active material mixture on one end in the width direction of the positive electrode foil. The positive uncoated portion 34b and the negative uncoated portion 32b are regions where the metal surfaces of electrode foil are exposed. The positive and negative uncoated portions 34b and 32b are wound so as to be located on one end and the other end in a winding axial direction (X direction in FIG. 4).

For the negative plate 32, 10 parts by weight of polyvinylidene fluoride (hereinafter, will be called PVDF) were added as a binding agent to 100 parts by weight of amorphous carbon powder that is a negative electrode active material. Moreover, N-methylpyrrolidone (hereinafter, will be called NMP) was added as a dispersing solvent to the powder and was mixed to prepare a negative material mixture. The negative material mixture was applied to both surfaces of copper foil (negative electrode foil) having a thickness of 10 μm, except for a current collecting portion (negative uncoated portion). After that, the foil was dried, pressed, and cut to obtain a negative plate that had a portion coated with the negative active material without containing copper foil with a thickness of 70 μm.

In the present embodiment, the negative active material was amorphous carbon. The negative active material is not limited to amorphous carbon and thus may be natural graphite allowing insertion and desorption of lithium ions, various artificial graphite materials, carbonaceous materials such as coke, a compound of materials such as Si and Sn (e.g., SiO or TiSi₂), or a composite material thereof. The forms of particles include scaly, spherical, fibrous, and massive forms and are not particularly limited.

For the positive plate 34, 10 parts by weight of scaly graphite as a conductive material and 10 parts by weight of PVDF as a binding agent were added to 100 parts by weight of lithium manganate (chemical formula: LiMn₂O₄) that is a positive active material. Moreover, NMP was added as a dispersing solvent to the material and then mixed to prepare a positive material mixture. The positive material mixture was applied to both surfaces of aluminum foil (positive electrode foil) having a thickness of 20 μm, except for an uncoated current collecting portion (positive uncoated portion). After that, the foil was dried, pressed, and cut to obtain a positive plate that has a portion coated with the positive active material without containing aluminum foil with a thickness of 90 μm.

In the present embodiment, the positive active material was lithium manganate. The positive active material may be another lithium manganate having a spinel crystal structure, a lithium manganese complex oxide partially substituted by or doped with a metallic element, lithium cobaltate having a laminar crystal structure, lithium titanate, or a lithium-metal composite oxide obtained by substitution or doping of some of these substances with metallic elements.

In the present embodiment, the bonding material of a coated portion on the positive plate and the negative plate is PVDF. The bonding material may be polytetrafluoroethylene (PTFE), polyethylene, polystyrene, polybutadiene, butyl rubber, nitrile rubber, styrene-butadiene rubber, polysulfide rubber, nitrocellulose, cyanoethyl cellulose, various latexes, acrylonitrile, vinyl fluoride, vinylidene fluoride, propylene fluoride, chloroprene fluoride, a polymer containing an acrylic resin, and a mixture of these substances.

The shaft core 80 includes the wound resin sheet 81 having higher flexural rigidity than the positive plate 34, the negative plate 32, and the separators 33 and 35. As shown in FIG. 4E, the shaft core 80 includes an innermost portion 82 forming the innermost periphery of the shaft core 80 and an extended portion 83 from the innermost portion 82 to the winding terminal end.

The resin sheet 81 is larger in thickness than the negative plate 32, the positive plate 34, and the separators 33 and 35 and is made of an insulating resin material having rigidity. The width of the resin sheet 81 is desirably not smaller than that of the negative coated portion 32a in the winding axial direction (X direction) so as to wind the negative coated portion 32a in contact with the overall outermost surface of the shaft core 80. Moreover, when the positive uncoated portion 34b and the negative uncoated portion 32b are collectively welded in the thickness direction (Z direction), the resin sheet 81 preferably has a width that does not cause insulation between pieces of metallic foil. In the present embodiment, the width of the resin sheet 81 is set at the same width as the separators 33 and 35.

The shaft core 80 includes the wound resin sheet 81 having higher flexural rigidity than the negative plate 32, the positive plate 34, and the separators 33 and 35. Thus, the elastic force of the shaft core 80 can tightly place the separators 33 and 35 and the negative plate 32 along the outer surface of the shaft core 80, and also place the positive plate 34, which is located outside the shaft core 80, along the shaft core 80. This can prevent looseness of the winding start ends of the separators 33 and 35, the negative plate 32, and the positive plate 34 toward the center of winding.

In the present embodiment, the shaft core 80 includes the resin sheet 81 that is a PP sheet having a thickness of 150 μm. The resin sheet 81 used in a battery does not cause problems such as deterioration, has higher flexural rigidity than the negative plate 32, and can tightly place the negative plate 32 along the outer periphery of the shaft core 80. The material, dimensions, and so on of the resin sheet 81 are not limited as long as the resin sheet 81 has insulation.

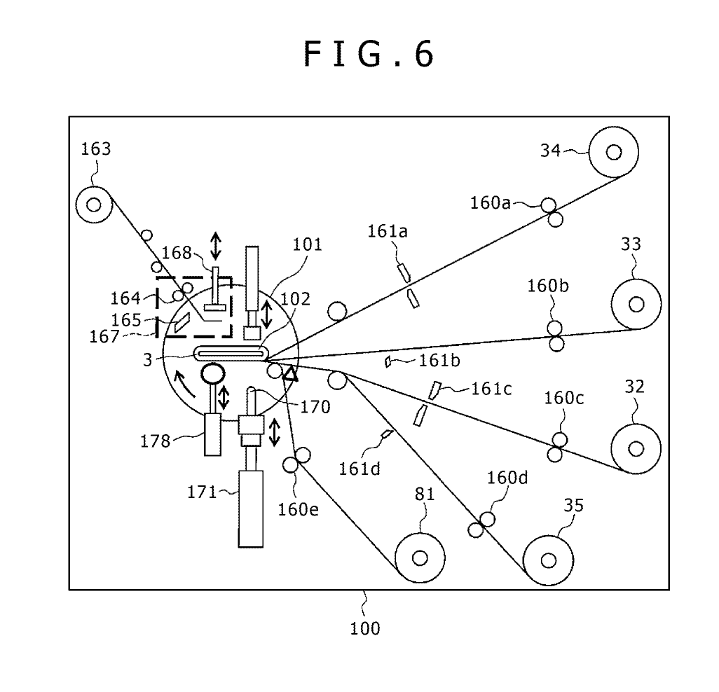

FIG. 6 shows a structural example of the winder 100.

The winder 100 includes a spindle 101 that is rotatably supported at the center of the winder and is rotated clockwise by a rotating unit (not shown). There is provided, on one side of the spindle 101, a feeder for feeding the positive electrode 34, the separator 33 (first separator), the negative electrode 32, the separator 35 (second separator), and the resin sheet 81 to the spindle 101.

The feeder holds the rolls of the positive electrode 34, the separator 33, the negative electrode 32, the separator 35, and the resin sheet 81 in this order from the upper right of the feeder. The rolls are fed to the spindle 101 from the outer end of the winder. The winder 100 further includes feed rollers 160a to 160e that feed the electrodes 34 and 32, the separators 33 and 35, and the resin sheet 81 for a predetermined length and cutters 161a to 161e that cut the electrodes 34 and 32, the separators 33 and 35, and the resin sheet 81 at a predetermined length.

The spindle 101 includes a flat winding core 102 that has a holding portion 103 for holding the winding start end of the resin sheet 81. Bonding means 167 is provided near the winding core 102. The bonding means 167 rotates the winding core 102 to form the wound electrode body 3 and then bonds adhesive tape 163 to prevent unwinding of the wound electrode body 3. A predetermined length of the adhesive tape 163 is fed by a feed mechanism 164, is cut by a cutter 165 at a predetermined length, and is bonded to the wound electrode body 3.

Furthermore, a heater head 170 and a heater lifting mechanism 171 are provided near the spindle 101. The heater head 170 that thermally welds the separators 33 and 35 to the resin sheet 81 wound around the winding core 102. The heater lifting mechanism 171 lifts the heater head 170 to a predetermined position and then presses the heater head 170.

Moreover, a temporarily pressing mechanism 178 is provided to hold the resin sheet 81 to be cut without being unwound. In another embodiment, the separators may be bonded with adhesive tape instead of thermal welding. Thus, in this case, the heater head 107 and the heater lifting mechanism 171 are replaced with a mechanism (not shown) similar to the bonding means 167 for bonding the tape.

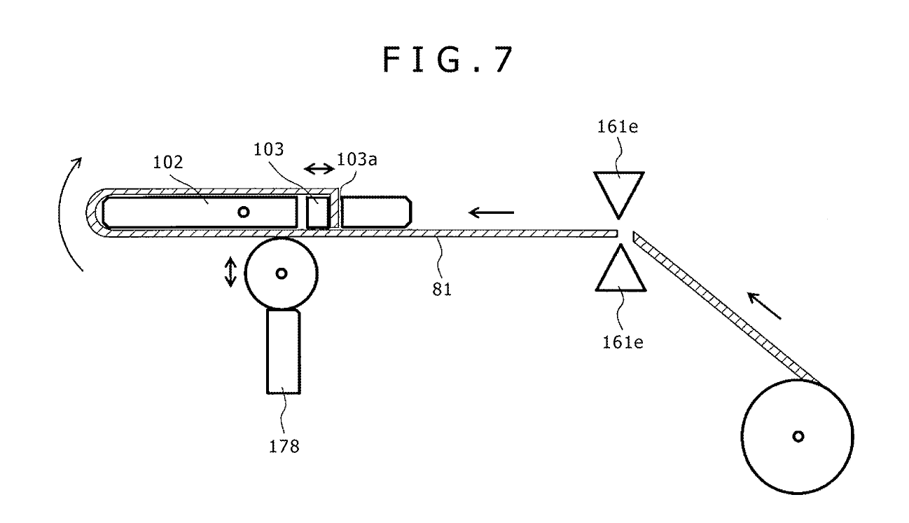

FIG. 7 is an explanatory drawing of a method of winding the resin sheet around the winding core.

The winding core 102 is provided to wind the resin sheet 81 so as to form the shaft core 80. The winding core 102 is shaped like a flat plate that is larger in width than the resin sheet 81. The winding core 102 is rotatably fixed to the spindle 101 so as to align the winding axis with the center of rotation of the spindle 101.

The winding core 102 includes the holding portion 103 for holding the winding start end of the resin sheet 81. The holding portion 103 is configured to increase or reduce the width of an insertion groove 103a formed along the winding axial direction. The end of the resin sheet 81 is inserted into the insertion groove 103a, and then the groove width is reduced so as to hold the winding start end of the resin sheet 81.

The winding start end of the resin sheet 81 is inserted into the insertion groove 103a and is held by the holding portion 103. The winding core 102 is then rotated to cut the resin sheet 81 with the cutter 161e at a length of at least one turn of the resin sheet 81 around the winding core 102. The resin sheet 81 is pressed to the winding core 102 with the temporarily pressing roller of the temporarily pressing mechanism 178 and thus is held without being unwound.

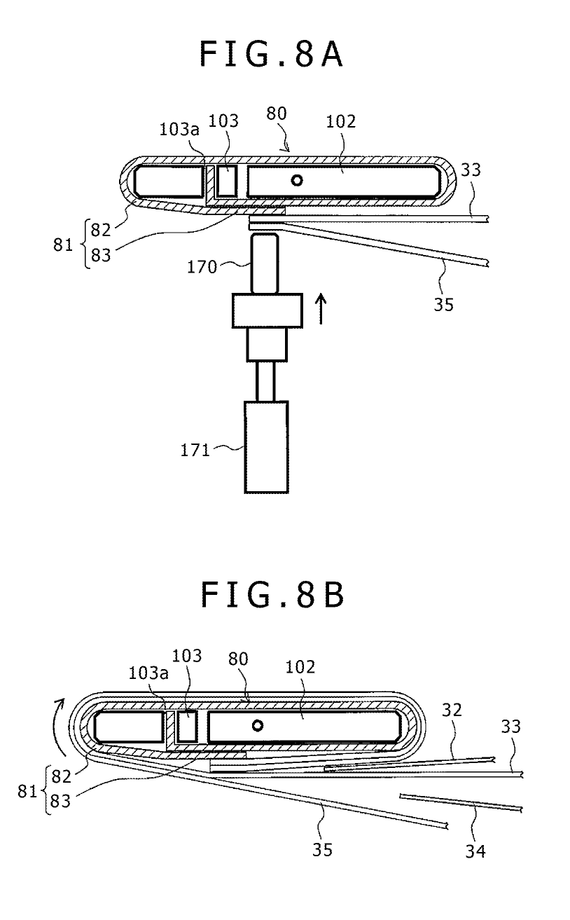

FIG. 8A is a cross-sectional conceptual diagram showing a bonded structure of the shaft core and the separators according to the present embodiment. FIG. 8B is an explanatory drawing of a winding method around the shaft core according to the present embodiment.

As shown in FIG. 8A, the shaft core 80 is formed by rotating the winding core 102 while the winding start end of the resin sheet 81 is held by the holding portion 103. The shaft core 80 includes the innermost portion 82 forming the innermost periphery of the shaft core 80 and the extended portion 83 that is opposed as an overlap margin to the outer periphery of the innermost portion 82. The extended portion 83 may be so long as to be wound at least one turn around the innermost portion 82.

Subsequently, the winding start end of the separator 33 and the winding start end of the separator 35 are fed between the extended portion 83 and the heater head 170, the heater head 170 is lifted by the heater lifting mechanism 171, the stacked winding start ends of the separators 33 and 35 are thermally welded to the outer surface of the extended portion 83 by the heater head 170, and then the winding start ends of the separators 33 and 35 are integrally bonded to the extended portion 83 of the shaft core 80.

In the present embodiment, the resin sheet 81 is wound around the winding core 102 at least one turn (the total length of the innermost portion 82 and the extended portion 83), and then the separators 33 and 35 are thermally welded to be integrally bonded to the outer surface of the extended portion 83 of the shaft core 80.

After that, as shown in FIG. 8B, the winding core 102 is rotated to wind only the separators 33 and 35 around the shaft core 80 at least one turn, forming a separator winding portion. Moreover, the winding start ends of the negative plate 32 and the positive plate 34 are bonded between the separators 33 and 35 and then are further wound to fabricate the wound electrode body 3 having a predetermined thickness.

The wound electrode body 3 is removed along the rotation axis from the extended insertion groove 103a of the holding portion 103 so as to be removed from the winding core 102. Furthermore, the wound electrode body 3 is compressed in a winding thickness direction (Z direction), flattening the shaft core 80 of the wound electrode body 3 in the winding thickness direction as shown in FIG. 4C which only illustrates the shaft core 80.

When the separators 33 and 35 are thermally welded to the extended portion 83 of the shaft core 80, the bonded portion has irregularities caused by the molten resin sheet 81 and separators 33 and 35. The negative plate 32 and the positive plate 34 that are wound around the bonded portion with such irregularities are not uniformly wound. This may cause wrinkles or uneven step heights so as to form a gap between the electrodes, leading to a reduction in service life.

In the present embodiment, the separator winding portion and the shaft core 80 co-operate so as to absorb and reduce irregularities on the bonded portion.

In the separator winding portion, the separators 33 and 35 are thermally welded to the shaft core 80, and then only the separators 33 and 35 are wound at least one turn so as to connect to the bonded portion, thereby absorbing and reducing irregularities on the bonded portion.

The shaft core 80 including the resin sheet 81 has a certain level of elasticity. Thus, the formation of the separator winding portion can deform the shaft core 80 so as to dent the overall irregularities on the bonded portion toward the shaft center, achieving a smooth surface. Thus, the negative plate 32 and the positive plate 34 can be uniformly wound around the bonded portion so as to prevent wrinkles and uneven step heights. This can prevent the formation of a gap between the electrodes and a reduction in service life.

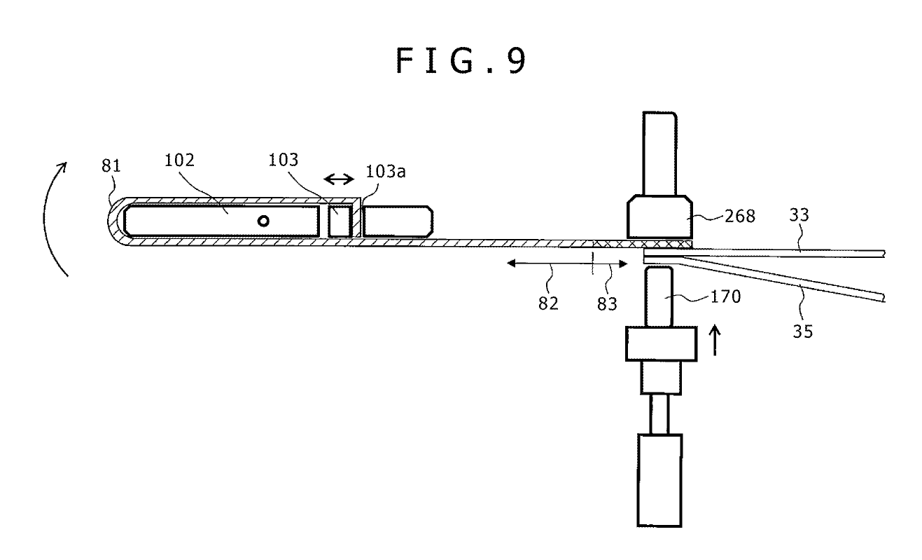

FIG. 9 is a cross-sectional conceptual diagram showing an example of a method of bonding the shaft core and the separators according to the present embodiment.

In the bonding method, the resin sheet 81 having a length of at least one turn (the total length of the innermost portion 82 and the extended portion 83) is wound a half turn around the winding core 102, and then the extended portion 83 is kept protruding in a direction that separates from the innermost portion 82. Subsequently, the stacked winding start ends of the separators 33 and 35 are fed between the extended portion 83 and the heater head 170, the heater head 170 is lifted by the heater lifting mechanism 171, and then the winding start ends of the separators 33 and 35 are thermally welded to the outer surface of the extended portion 83 by the heater head 170, integrally bonding the winding start ends of the separators 33 and 35 to the extended portion 83 of the shaft core 80. At this point, a pressing mechanism 268, which is not shown in the winder 100 of FIG. 6, is opposed to the heater head 170 via the resin sheet 81 and the separators 33 and 35 and is used as a rear retainer of the heater head 170.

In the present embodiment, the resin sheet 81 is wound around the winding core 102 and then the separators 33 and 35 are thermally welded so as to be integrated with the outer surface of the extended portion 83 protruding from the winding core 102. After that, the winding core 102 is rotated so as to fabricate the wound electrode body 3 as in FIG. 8. Thus, even if the winding core 102 has a small thickness with low rigidity, the wound electrode body 3 can be fabricated. The same effect can be obtained by bonding of tape (not shown) instead of thermal welding.

### Second Embodiment

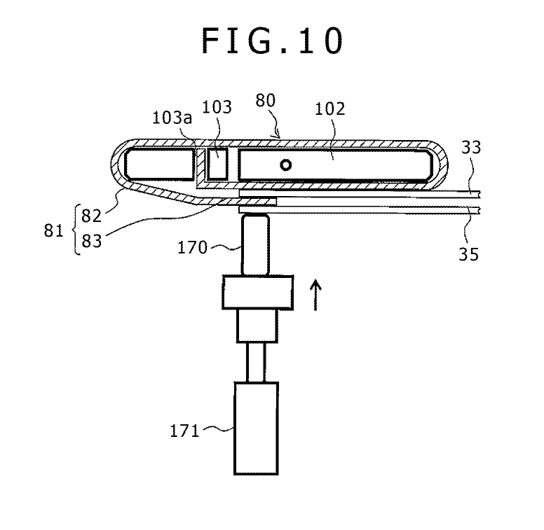

FIG. 10 is a cross-sectional conceptual diagram showing a bonded structure of a shaft core and separators according to the present embodiment.

A feature of the present embodiment is that the winding start end of a separator 33 is thermally welded to the inner surface of an extended portion 83 of a shaft core 80 while the winding start end of a separator 35 is thermally welded to the outer surface of the extended portion 83 of the shaft core 80, bonding the shaft core 80 to the separators 33 and 35.

The separators 33 and 35 are fed between a winding core 102 and a heater head 170 so as to hold the winding terminal end of a resin sheet 81 wound around the winding core 102. The winding start end of the separator 33 is opposed to the inner surface of the extended portion 83 while the winding start end of the separator 35 is opposed to the outer surface of the extended portion 83.

Subsequently, the heater head 170 is lifted by a heater lifting mechanism 171, and then the extended portion 83 held between the winding start ends of the separators 33 and 35 is thermally welded by the heater head 170, integrally bonding the separators 33 and 35 to the extended portion 83 of the shaft core 80.

After that, the winding core 102 is rotated to wind only the separators 33 and 35 around the shaft core 80 at least one turn, forming a separator winding portion. Moreover, the winding start ends of a negative plate 32 and a positive plate 34 are bonded between the separators 33 and 35 and then are further wound to fabricate a wound electrode body 3 having a predetermined thickness. As in the first embodiment, the wound electrode body 3 is removed from the winding core 102 and then is compressed in a winding thickness direction (Z direction), flattening the shaft core 80 in a winding thickness direction.

For example, if a material having high heat resistance is applied to the surfaces of the separators 33 and 35 so as to be opposed to the positive plate, it may be difficult to thermally weld the separators 33 and 35 to the resin sheet 81 in the first embodiment. In the first embodiment, however, the surfaces of the separators 33 and 35 opposed to the resin sheet 81 can be thermally welded and thus can be easily bonded with reliability, achieving particularly high effectiveness.

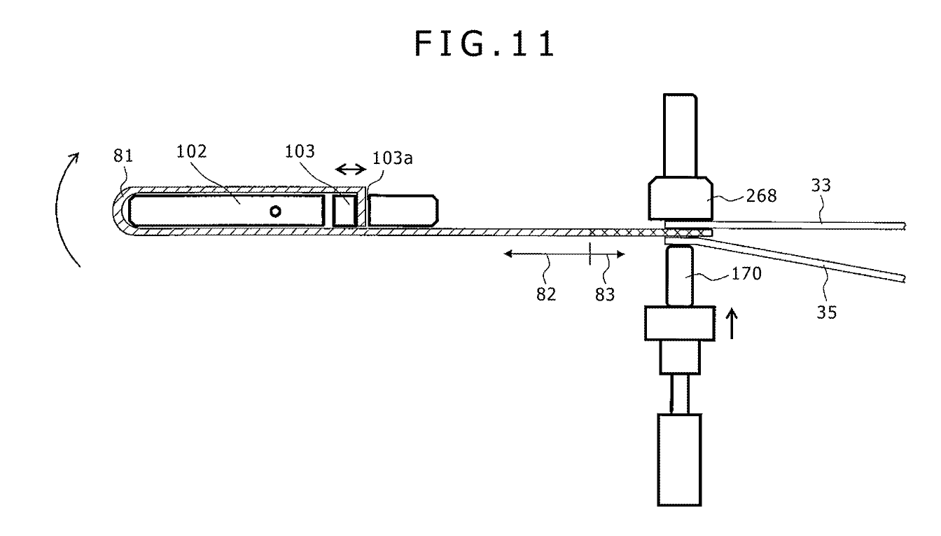

FIG. 11 is a cross-sectional conceptual diagram showing an example of a method of bonding the shaft core and the separators according to the present embodiment.

In the bonding method, the resin sheet 81 having a length of at least one turn (the total length of the innermost portion 82 and the extended portion 83) is wound a half turn around the winding core 102, and then the extended portion 83 is kept protruding in a direction that separates from the innermost portion 82. Subsequently, the winding start end of the separator 33 is opposed to the inner surface of the extended portion 83 while the winding start end of the separator 35 is opposed to the outer surface of the extended portion 83.

The heater head 170 is then lifted by the heater lifting mechanism 171 and the winding start ends of the separators 33 and 35 are thermally welded to the inner and outer surfaces of the extended portion 83 by the heater head 170, integrally bonding the winding start ends of the separators 33 and 35 to the extended portion 83 of the shaft core 80.

At this point, a pressing mechanism 268, which is not shown in a winder 100 of FIG. 6, is opposed to the heater head 170 via the resin sheet 81 and the separators 33 and 35 and is used as a rear retainer of the heater head 170.

Alternatively, a pair of heater heads 170 may be prepared to thermally weld the separators 33 and 35 while holding the inner and outer surfaces of the separators 33 and 35. With this configuration, for example, even if a material having high heat resistance and poor heat transfer is applied to one surface of each of the separators 33 and 35 at the position of a positive electrode, the surfaces of the separators 33 and 35 opposed to the resin sheet 81 can be thermally welded and thus can be easily bonded with reliability.

### Third Embodiment

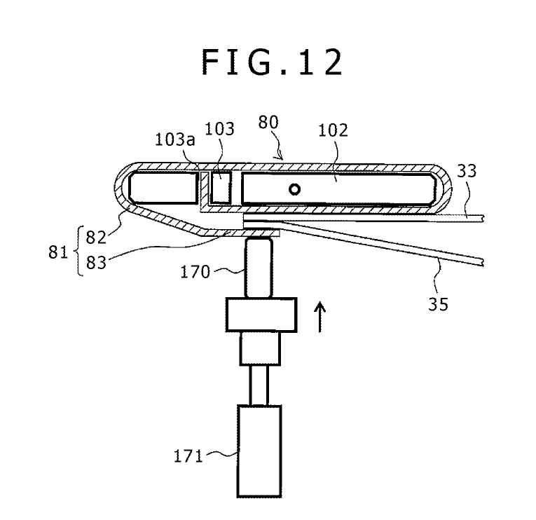

FIG. 12 is a cross-sectional conceptual diagram showing a bonded structure of a shaft core and separators according to the present embodiment.

A feature of the present embodiment is that the winding start ends of separators 33 and 35 are thermally welded to the inner surface of an extended portion 83 of a shaft core 80 so as to bond the shaft core 80 to the separators 33 and 35.

As shown in FIG. 12, the shaft core 80 is formed by rotating the winding core 102 one turn while the winding start end of a resin sheet 81 is held by a holding portion 103. The shaft core 80 includes an innermost portion 82 and an extended portion 83 serving as an overlap margin on the outer periphery of the innermost portion 82. The extended portion 83 is opposed to the outer periphery of the innermost portion 82.

Subsequently, the winding start end of the separator 35 is fed between the winding terminal end of the resin sheet 81 and the outer surface of the resin sheet 81 opposed to the inner surface of the winding terminal end of the extended portion 83 (in the present embodiment, the outer surface of the innermost portion 82).

Subsequently, a heater head 170 is lifted by a heater lifting mechanism 171, and then the stacked winding start ends of the separators 33 and 35 are thermally welded to the inner surface of the extended portion 83 by the heater head 170, integrally bonding the separators 33 and 35 to the extended portion 83 of the shaft core 80.

In the present embodiment, the resin sheet 81 is wound around a winding core 102 at least one turn (the total length of an innermost portion and an extended portion), and then the separators 33 and 35 are thermally welded to the inner surface of the extended portion 83 of the shaft core 80, integrally bonding the separators 33 and 35 to the inner surface of the extended portion 83 of the shaft core 80. Subsequently, the winding core 102 is rotated to wind the separators 33 and 35 around the shaft core 80 at least one turn, the winding start ends of a negative plate 32 and a positive plate 34 are bonded between the separators 33 and 35 and then are further wound to fabricate a wound electrode body 3 having a predetermined thickness. The wound electrode body 3 is removed along the rotation axis from an extended insertion groove 103a of the holding portion 103 so as to be removed from the winding core 102. Furthermore, the wound electrode body 3 is compressed in a winding thickness direction (Z direction), flattening the shaft core 80 of the wound electrode body 3 in the winding thickness direction.

According to the present embodiment, the winding start ends of the separators 33 and 35 are held between the inner surface of the extended portion 83 and the outer surface of the resin sheet 81 opposed to the inner surface (the outer surface of the innermost portion 82 in the present embodiment) and thus the winding start ends of the separators 33 and 35 are bonded by the friction of holding on the resin sheet 81 as well as bonding by welding. This can more firmly bond the separators 33 and 35 to the shaft core 80.

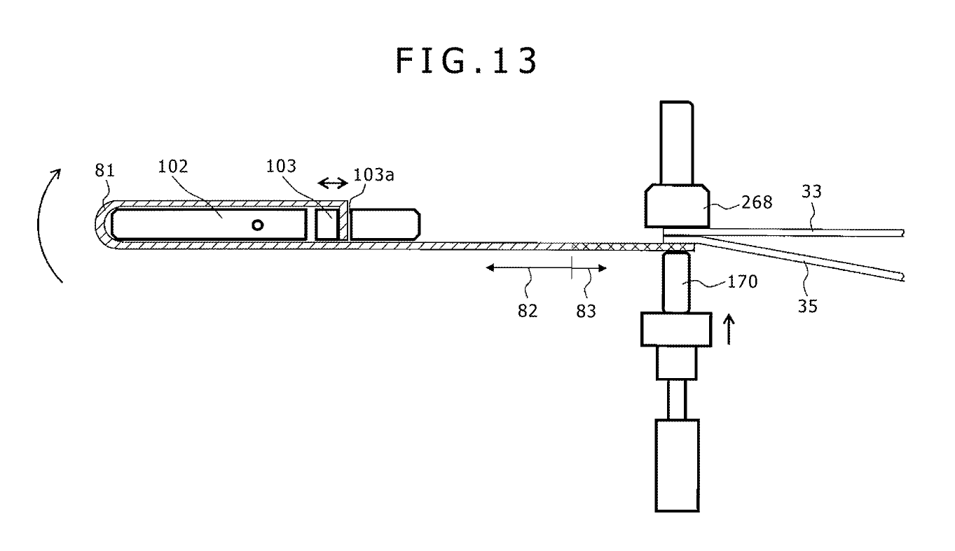

FIG. 13 is a cross-sectional conceptual diagram showing a method of bonding the shaft core and the separators according to the present embodiment.

In the bonding method, the resin sheet 81 having a length of at least one turn (the total length of the innermost portion 82 and the extended portion 83) is wound around the winding core 102 a half turn, and then the extended portion 83 is kept protruding in a direction that separates from the innermost portion 82. Subsequently, the winding start ends of the separators 33 and 35 are fed at a position opposed to the inner surface of the extended portion 83. The heater head 170 is then lifted by the heater lifting mechanism 171 and the stacked winding start ends of the separators 33 and 35 are thermally welded to the inner surface of the extended portion 83 by the heater head 170, integrally bonding the winding start ends of the separators 33 and 35 to the extended portion 83 of the shaft core 80. At this point, a pressing mechanism 268, which is not shown in a winder 100 of FIG. 6, is opposed to the heater head 170 via the resin sheet 81 and the separators 33 and 35 and is used as a rear retainer of the heater head 170.

In the present embodiment, the resin sheet 81 is wound around the winding core 102, and then the separators 33 and 35 are thermally welded to the protruding portion of the resin sheet 81 from the winding core 102, that is, the inner surface of the extended portion 83 of the shaft core 80, integrally bonding the separators 33 and 35 to the inner surface of the extended portion 83 of the shaft core 80. The winding core 102 is then rotated so as to fabricate the wound electrode body 3 as in FIG. 8. Thus, even if the winding core 102 has a small thickness and low rigidity, the wound electrode body 3 can be fabricated. The same effect can be obtained by bonding of tape (not shown) instead of thermal welding. The positional relationship between the pressing mechanism 268 and the heater head 170 in the winder 100 of FIG. 6 may be vertically reversed.

### Fourth Embodiment

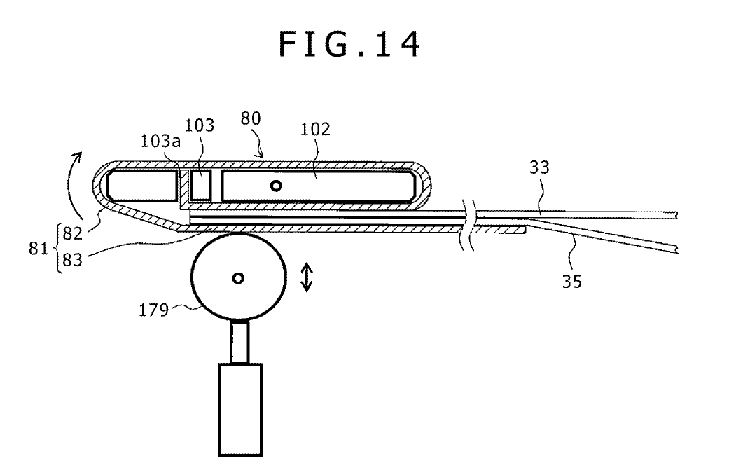

FIG. 14 is a cross-sectional conceptual diagram showing a bonded structure of a shaft core and separators according to the present embodiment.

A feature of the present embodiment is that separators 33 and 35 are bonded to a shaft core 80 while the winding start ends of the separators 33 and 35 are held between the inner surface of an extended portion 83 of the shaft core 80 and the outer surface of a resin sheet 81 opposed to the inner surface (the outer surface of an innermost portion 82 in the present embodiment).

As shown in FIG. 14, the shaft core 80 is formed by rotating a winding core 102 one turn while the winding start end of the resin sheet 81 is held by a holding portion 103. The shaft core 80 includes an innermost portion 82 and an extended portion 83 serving as an overlap margin on the outer periphery of the innermost portion 82. The extended portion 83 is opposed to the outer periphery of the innermost portion 82.

Subsequently, the winding start ends of the separators 33 and 35 are fed at a position opposed to the inner surface of the winding terminal end of the resin sheet 81. A touch roller 179 for preventing unwinding is lifted to hold the separators 33 and 35 between the extended portion 83 and the outer surface of the resin sheet 81 opposed to the inner surface of the extended portion 83. This prevents removal of the separators 33 and 35 with a friction force so as to integrally bond the separators 33 and 35 to the shaft core 80.

In the present embodiment, the resin sheet 81 is wound around the winding core 102 at least one turn, and then the first separator 33 and the second separator 35 are stacked on the inner surface of the extended portion 83 and are fixed by the touch roller for preventing unwinding. After that, the winding core 102 is rotated one turn to wind the separators 33 and 35 around the shaft core 80 at least one turn. The touch roller 171 is then retracted and the winding core 102 is further rotated to wind the separators 33 and 35.

The shaft core 80 and the separators 33 and 35 are bonded using friction forces and thus the resin sheet 81 preferably has a large friction coefficient. As the separators 33 and 35 are held with a longer length between the inner surface of the extended portion 83 and the outer surface of the resin sheet 81, a larger friction force can be obtained. For example, the separators 33 and 35 are preferably wound around the innermost portion 82 at least a half turn, preferably at least one turn.

The present embodiment eliminates the need for bonding the shaft core 80 and the separators 33 and 35 by thermal welding and thus does not have irregularities caused by thermal welding on a bonded portion. Thus, even if a negative plate 32 and a positive plate 34 are wound on the bonded portion, wrinkles or uneven step heights do not occur. Moreover, the step of thermal welding can be eliminated and thus an improved production tact can be expected.

### Fifth Embodiment

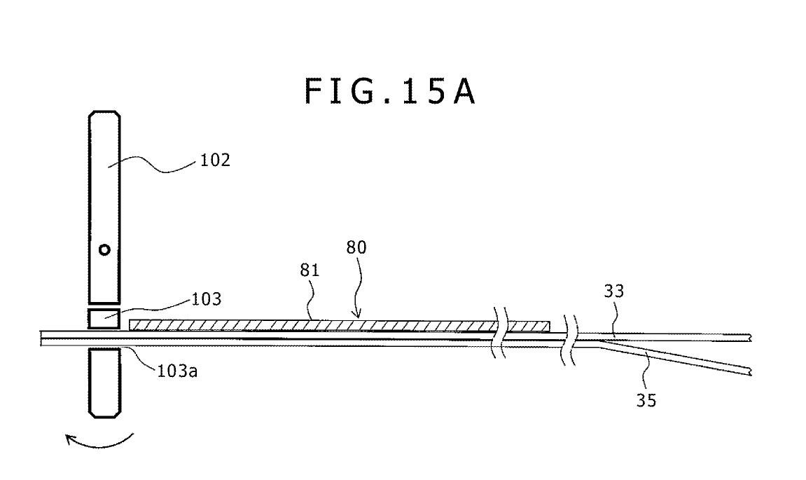

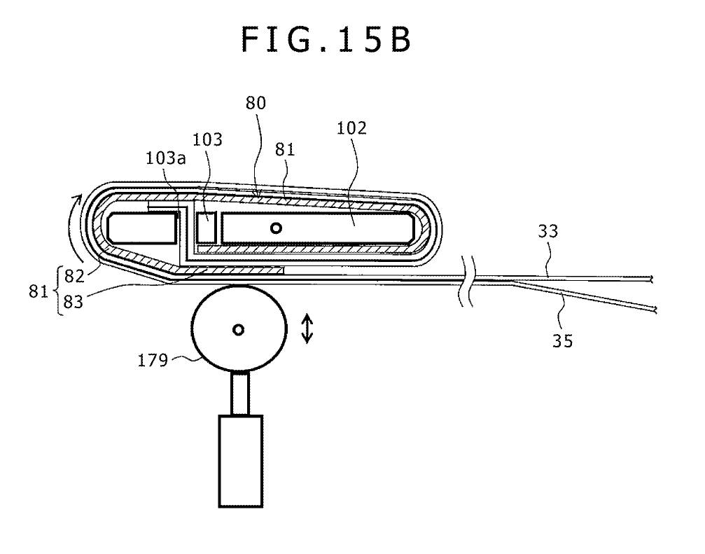

FIG. 15A is an explanatory drawing of a winding method of a shaft core according to the present embodiment. FIG. 15B is a cross-sectional conceptual diagram showing a bonded structure of the shaft core and separators according to the present embodiment.

Unlike in the foregoing embodiments, a feature of the present embodiment is that the winding start ends of separators 33 and 35 are partially held by a holding portion 103 of a winding core 102, the winding core 102 is rotated one turn with a resin sheet 81 disposed on the separator 33, and thus the winding start ends of the separators 33 and 35 are bonded to a shaft core 80 while being held between the inner surface of an extended portion 83 of the shaft core 80 and the outer surface of the resin sheet 81 opposed to the inner surface (the outer surface of an innermost portion 82 in the present embodiment). Furthermore, the winding start ends of the separators 33 and 35 are located inside the shaft core 80.

First, the stacked separators 33 and 35 are inserted into an insertion groove 103a of the holding portion 103, and then the groove width of the insertion groove 103 is reduced while the winding start ends of the separators 33 and 35 are protruded by a predetermined length. Thus, the separators 33 and 35 are held by the holding portion 103 of the winding core 102.

As shown in FIG. 15A, the resin sheet 80 is then disposed on the separator 33 held by the holding portion 103. Subsequently, a touch roller 179 for preventing unwinding is lifted and then the winding core 102 is rotated one turn, forming the shaft core 80 around the winding core 102 as shown in FIG. 15. The shaft core 80 includes the innermost portion 82 and the extended portion 83 serving as an overlap margin on the outer periphery of the innermost portion 82. The extended portion 83 is opposed to the outer periphery of the innermost portion 82. The winding start side of the separator 33 and the winding start side of the separator 35 are partially disposed at a position opposed to the inner surface of the winding terminal end of the resin sheet 81. The separators 33 and 35 extending along the shaft core 80 are held by the shaft core 80 so as to be integrally bonded to the shaft core 80. The winding start ends of the separators 33 and 35 are protruded from a point between the innermost portion 82 and the extended portion 83 to the center of the shaft core 80 and are disposed inside the shaft core 80.

In the present embodiment, as an example of the winding start ends, the winding start sides of the separators 33 and 34 are partially held by the holding portion 103 of the winding core 102. The present invention is not limited to this configuration. The winding start ends of the separators 33 and 34 may be held instead. Moreover, in the present embodiment, the touch roller 179 for preventing unwinding was used to extend the shaft core 80 and the separators 33 and 35 along the winding core 102 but the present invention is not limited to the use of the touch roller 179. The wound electrode body 3 can be fabricated without using the touch roller 179. Furthermore, in the present embodiment, only the parts of the winding start sides of the separators 33 and 34 are held by the holding portion 103 and the insertion groove 103a of the winding core 102. The present invention is not limited to this configuration. The end or a part of the shaft core 80 may be held concurrently with or separately from the separators 33 and 35.

The present embodiment eliminates the need for bonding the shaft core 80 and the separators 33 and 35 by thermal welding. Unlike in the fourth embodiment, the touch roller 179 for preventing unwinding is used to extend the shaft core 80 and the separators 33 and 35 along the winding core 102 but is not used to fix the separators 33 and 35. This can achieve stable production and increase the rotation speed of the winding core 102. Thus, an improved production tact can be expected.

The embodiments of the present invention were described in detail. The present invention is not limited to the embodiments and thus various design changes may be made within the spirit of the invention as described in the appended claims. For example, the configurations of the embodiments specifically described to illustrate the present invention are not intended to limit the scope of the present invention. The configuration of one of the embodiments may be partially replaced with the configuration of another one of the embodiments or the configuration of one of the embodiments may be added to the configuration of another one of the embodiments. The addition, deletion, and replacement of configurations are possible partially in the configurations of the embodiments.

### LIST OF REFERENCE SIGNS

1 lithium-ion secondary battery
2 battery container
3 wound electrode body
4 lid assembly
5 power generating element assembly
11 battery case
21 battery lid
32 negative plate (negative electrode)
33 separator (first separator)
34 positive plate (positive electrode)
35 separator (second separator)
41 insulating protective film
51 positive terminal (electrode terminal)
52,62 external terminal
53,63 connection terminal
54,64 current collecting terminal
61 negative terminal (electrode terminal)
71 gas release vent
72 electrolyte inlet
73 electrolyte stopper
80 shaft core
81 resin sheet
82 innermost portion
83 extended portion
100 winder
101 spindle
170 heater head

1. A flat wound secondary battery comprising a wound electrode body including a positive electrode and a negative electrode that are wound flat around a shaft core with a separator interposed between the electrodes,
the shaft core including a wound resin sheet having higher flexural rigidity than the positive electrode, the negative electrode, and the separator, the shaft core including an innermost portion that forms an innermost periphery of the shaft core and an extended portion to a winding terminal end of the resin sheet from the innermost portion, and
the separator including a bonded portion to the extended portion and a separator winding portion that winds only the separator at least one turn around the shaft core so as to connect the separator to the bonded portion.

2. The flat wound secondary battery according to claim 1, wherein the separator includes a first separator and a second separator that are bonded to an outer surface of the extended portion by thermal welding.

3. The flat wound secondary battery according to claim 1, wherein the separator includes a first separator bonded to an inner surface of the extended portion by thermal welding and a second separator bonded to an outer surface of the extended portion by thermal welding.

4. The flat wound secondary battery according to claim 1, wherein the separator includes a first separator and a second separator that are bonded to an inner surface of the extended portion by thermal welding.

5. The flat wound secondary battery according to claim 1, wherein the separator is bonded by holding a winding start end of the separator between an inner surface of the extended portion and an outer surface of the resin sheet opposed to the inner surface of the extended portion.

6. The flat wound secondary battery according to claim 5, wherein the separator has a winding start end that protrudes from a point between the innermost portion and the extended portion to a center of the shaft core.

7. A method for producing a flat wound secondary battery including a positive electrode and a negative electrode that are wound flat around a shaft core with a separator interposed between the electrodes,
the method comprising the steps of:
forming the shaft core by winding a resin sheet having higher flexural rigidity than the positive electrode, the negative electrode, and the separator;
bonding the separator to an extended portion extended to a winding terminal end from the innermost portion forming an innermost periphery of the shaft core; and
forming a separator winding portion by winding only the separator at least one turn around the shaft core so as to connect the separator to a bonded portion to the extended portion.

8. The method for producing a flat wound secondary battery according to claim 7, wherein in the step of bonding the separator, a winding start end of the separator is thermally welded to an outer surface of the extended portion, the extended portion being opposed to an outer periphery of the innermost portion.

9. The method for producing a flat wound secondary battery according to claim 7, wherein in the step of bonding the separator, a winding start end of the separator is thermally welded to an outer surface of the extended portion, the extended portion protruding in a direction that separates from the innermost portion.

10. The method for producing a flat wound secondary battery according to claim 7, wherein in the step of bonding the separator, a winding start end of a first separator is thermally welded while being opposed to an inner surface of the extended portion and a winding start end of a second separator is thermally welded while being opposed to an outer surface of the extended portion, the extended portion being opposed to an outer periphery of the innermost portion.

11. The method for producing a flat wound secondary battery according to claim 7, wherein in the step of bonding the separator, a winding start end of a first separator is thermally welded while being opposed to an inner surface of the extended portion and a winding start end of a second separator is thermally welded while being opposed to an outer surface of the extended portion, the extended portion protruding in a direction that separates from the innermost portion.

12. The method for producing a flat wound secondary battery according to claim 7, wherein in the step of bonding the separator, a winding start end of the separator is thermally welded to an inner surface of the extended portion, the extended portion being opposed to an outer periphery of the innermost portion.

13. The method for producing a flat wound secondary battery according to claim 7, wherein in the step of bonding the separator, a winding start end of the separator is thermally welded to an inner surface of the extended portion, the extended portion protruding in a direction that separates from the innermost portion.

14. The method for producing a flat wound secondary battery according to claim 7, wherein in the step of bonding the separator, the separator is bonded while a winding start end of the separator is held between an inner surface of the extended portion and an outer surface of the resin sheet opposed to an inner surface of the extended portion, the extended portion being opposed to an outer periphery of the innermost portion.

15. The method for producing a flat wound secondary battery according to claim 14, wherein the separator has a winding start end that protrudes from a point between the innermost portion and the extended portion to a center of the shaft core.
